(19) United States
(12) Patent Application Publication
(10) Pub. No.: US 2006/0162309 A1
(43) Pub. Date: Jul. 27, 2006

(54) Cutter apparatus

(75) Inventor: Christopher M. Schloesser, Hudson, WI (US)

Correspondence Address: MERCHANT & GOULD PC, P.O. BOX 2903, MINNEAPOLIS, MN, 55402-0903, US

(73) Assignee: Oxbo International Corporation, Byron, NY (US)

(21) Appl. No.: 11/043,892

(22) Filed: Jan. 25, 2005

(51) Int. Cl. A01D 34/73

(52) U.S. Cl. 56/255

(57) ABSTRACT

A cutting system for plants includes opposed first cutting assemblies and opposed second cutting assemblies. The first cutting assemblies include a substantially vertical stack of cage type cutters and a lower cutter having stationary and rotating cutter members. The cage type cutters include an outer driven guard that moves the plants past the stationary cutters. Opener wheels have a diameter slightly greater than the cutters and engage posts and other objects to position the cutting assemblies and to prevent damage to the cutting assemblies and trellises. Side cutter assemblies are positioned forward of the vertical stack of first cutting assemblies and provide precision side cuts. The side cutters include stationary cutter members and rotating cutter members that provide a precise shearing action. The system rotational speed is controlled to maintain a speed proportional to the ground speed so that a substantially constant percentage of plant material is removed.

### BACKGROUND OF THE INVENTION

1. Field of the Invention

The present invention relates to a plant cutting system, and more particularly to a cutter system utilized for dormant pruning in vineyards and similar applications.

2. Description of the Prior Art

Devices for performing pruning and thinning operations in vineyards have recently become more widely used. Such devices are used throughout various stages of the growing cycle to remove excess portions of the plant to control yield, maintain plant structure and increase fruit exposure. By removing the excess and/or aged portions of plant material, the plant, such as a grapevine, is able to focus more resources on the fruit so that quality is improved while attaining a desired yield. Although such operations have historically been performed by hand, the need for more efficient ways of performing such tasks has increased to improve the efficiency and economics of the vineyard.

To reduce or eliminate some labor costs, mechanical devices have been developed to perform several of these tasks. Hedger and sickle bar type devices have been developed and have proven useful to create a box shaped profile along the vineyard cordons and trellis systems. Although such hedging devices work well in some dormant pruning applications, for others, improvements or alternate approaches are needed. In an effort to meet this need, barrel type rotary pruners have been utilized. Barrel pruners generally include a series of rotary cutting assemblies with blades oriented about a generally vertical axis. In certain vineyard and trellis configurations, barrel pruners have performed well in dormant pruning operations. However, safety, wear and damage to plants and trellises are a concern. Some devices utilize high speed rotating saw blades, which may pose a safety concern and are expensive to maintain. Other devices utilize rotating guards, which may reduce costs for blade replacement, but may also have an irregular or unsatisfactory cut. Although such devices provide adequate cutting in many applications, for some uses a more precise cut may be needed for portions being removed. In particular, it is often desired for the final cuts along the sides and top of a vine cordon to be more precise and without splintering or shattering remaining plant portions. Moreover, utilizing a system that protects the blades while still performing satisfactory cutting has not been achieved by the prior art. In addition, maintaining proper rotational speed for performing the cutting, as the ground speed of the vehicle or chassis changes is not provided by the prior art.

Proper positioning of the cutters has also been a problem. Maintaining the cutters at the correct position and allowing the cutters to follow closely around posts without damage provides design challenges. Spring type or gas spring type systems have been utilized that allow deflection of pruner assemblies. However, such systems do not provide for easy adjustment and do not have proper damping and/or provide for proper positioning.

It can be seen then that a new and improved cutting system is needed for mechanized vineyard pruning operations. Such a system should provide for controllable cutting assemblies that react proportionally to the speed of travel to maintain consistent removal through improved proportional speed control. Such a system should provide safe and reliable cutting without damaging the cutting devices, the trellises or permanent stationary portions of the plants. Such a system should also follow around trellis posts and other obstacles while maintaining proper position. Moreover, such devices should provide for a precise lower and side cut. The present invention addresses these, as well as other problems associated with such plant cutting systems.

### SUMMARY OF THE INVENTION

The present invention is directed to a cutting system for plants and in particular to a cutting system utilized for removing excess portions of plants trained on trellises, such as vertical shoot positioning trellises. The cutting system includes two first cutting assemblies, each having a stack of rotary cutter assemblies mounted about a substantially vertical rotational axis. The system mounts to a chassis so that the opposed first cutting assemblies extend on either side of trellises and remove undesirable portions of the plants. The cutting system also includes a pair of opposed second cutting assemblies mounted to perform side cuts to form a box type profile. In one embodiment, the second cutting assemblies are rotary type cutters that rotate about a substantially horizontal axis and make the side cuts. In another embodiment, the second cutting assemblies are reciprocating sickle bar type cutters that make the side cuts.

The first cutting assemblies are preferably pivotally mounted to a supporting frame so that the assemblies pivot away when engaging a post or other stationary objects, or when encountering resistance from the plant above a predetermined level. The rotary cutter assemblies include upper cutter assemblies with substantially rotating guards. The cutter assemblies with guards include a stationary cutter section that has cutter elements arranged to engage the plant; the guards are rotationally driven around a periphery of the cutters so that a shearing action with the stationary cutter elements is achieved.

An opener wheel is disposed within the stack of cutter assemblies to engage objects such as trellis posts and avoid damage to the cutter assembly. The opener wheel typically has a diameter slightly larger than the outermost diameter of the guards or cutter members. With this arrangement, the opener wheels engage the post or other stationary object to cause the cutting assemblies to deflect and/or cause to open, rather than the cutters striking objects. The cutting assemblies follow around trellis posts as the opener wheel engages the post to maintain the cutters away from engagement.

The first cutting assemblies also include a lower rotary cutter assembly. The lower cutter assembly includes a stationary cutter section and complementary rotating cutter section that work together to create a shearing action. The lower rotary cutters provide a precision cut that becomes a desirable finish cut over the remaining permanent portion of the plant. The lower cutter assembly has a slightly smaller diameter than the upper cutter assemblies to further decrease the chance of striking objects.

In one embodiment, the second cutting assemblies include a rotating cutter portion and a stationary cutter portion that are complementary to one another. The stationary and complementary cutter portions provide a precision cut forming a side of the box being formed on the trained plants. Guards provide added safety to the side cutters that are spaced forwardly or rearwardly from the first cutting assemblies to engage plants before or after the vertically stacked first cutting assemblies. In another embodiment, the second cutting assemblies are vertically extending sickle bar type cutters that form side cuts. In either embodiment, the second cutting assemblies may be positioned to precede or follow the first cutting assemblies.

The cutting assemblies include a hydraulic controller system. The control system provides for pivoting the cutting assemblies to an open transport position for entering and exiting vine rows and providing proper pressure and positioning during operation.

In operation, the rotational speed of the various cutter assemblies is maintained at a rate proportional to the ground speed through a controller. In this manner, the desired rate of plant engagement remains substantially constant, even as the travel speed varies. It has been found that a rotational speed of the periphery of the cutter assemblies greater than the ground speed is preferred. Rates of up to approximately three times the ground speed have provided excellent results. However, it can be appreciated that the proportional speed is easily changed with a programmable controller to optimize operations for variables such as trellis type, grape variety and/or terrain.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 is a front top perspective view of a first embodiment of a cutting apparatus according to the principles of the present invention;

FIG. 2 is a front elevational view of the cutting apparatus shown in FIG. 1;

FIG. 3 is a top plan view of the cutting apparatus shown in FIG. 1;

FIG. 4 is a rear elevational view of the cutting apparatus shown in FIG. 1;

FIG. 5 is a side elevational view of the cutting apparatus shown in FIG. 1;

FIG. 6 is a rear top perspective view of the cutting apparatus shown in FIG. 1;

FIG. 7 is a partially exploded perspective view of the cutting apparatus shown in FIG. 1;

FIG. 8 is a perspective view of a cutting assembly for the cutting apparatus shown in FIG. 1;

FIG. 9 is a partially exploded perspective view of the cutting assembly shown in FIG. 8;

FIG. 10 is a perspective view of a lower cutting assembly for the cutting apparatus shown in FIG. 1;

FIG. 11 is an exploded perspective view of the lower cutting assembly shown in FIG. 10;

FIG. 12 is a perspective view of a caged cutter for the cutting assembly shown in FIG. 8;

FIG. 13 is an exploded perspective view of the caged cutter shown in FIG. 12;

FIG. 14 is a perspective view of a lower cutter for the cutting assembly shown in FIG. 8;

FIG. 15 is an exploded perspective view of the lower cutter shown in FIG. 14;

FIG. 16 is a perspective view of a guide wheel for the cutting assembly shown in FIG. 8;

FIG. 17 is an exploded perspective view of the guide wheel shown in FIG. 16;

FIG. 18 is a perspective view of a cutting apparatus according to the principles of the present invention with the first cutting assemblies mounted forward of the second cutting assemblies;

FIG. 19 is a side elevational view of the cutting apparatus shown in FIG. 18;

FIG. 20 is a perspective view of a second embodiment of a cutting apparatus according to the principles of the present invention;

FIG. 21 is a side elevational view of the cutting apparatus shown in FIG. 20;

FIG. 22 is a front elevational view of the cutting apparatus shown in FIG. 20;

FIG. 23 is a top plan view of the cutting apparatus shown in FIG. 20;

FIG. 24 is a diagrammatic view of a hydraulic reducer/reliever and directional control circuit for the cutting apparatus of the present invention;

FIG. 25 is a diagrammatic view of a control system for the cutting apparatus of the present invention; and

FIG. 26 is a block diagram for the control system shown in FIG. 25.

### DETAILED DESCRIPTION OF THE PREFERRED EMBODIMENT

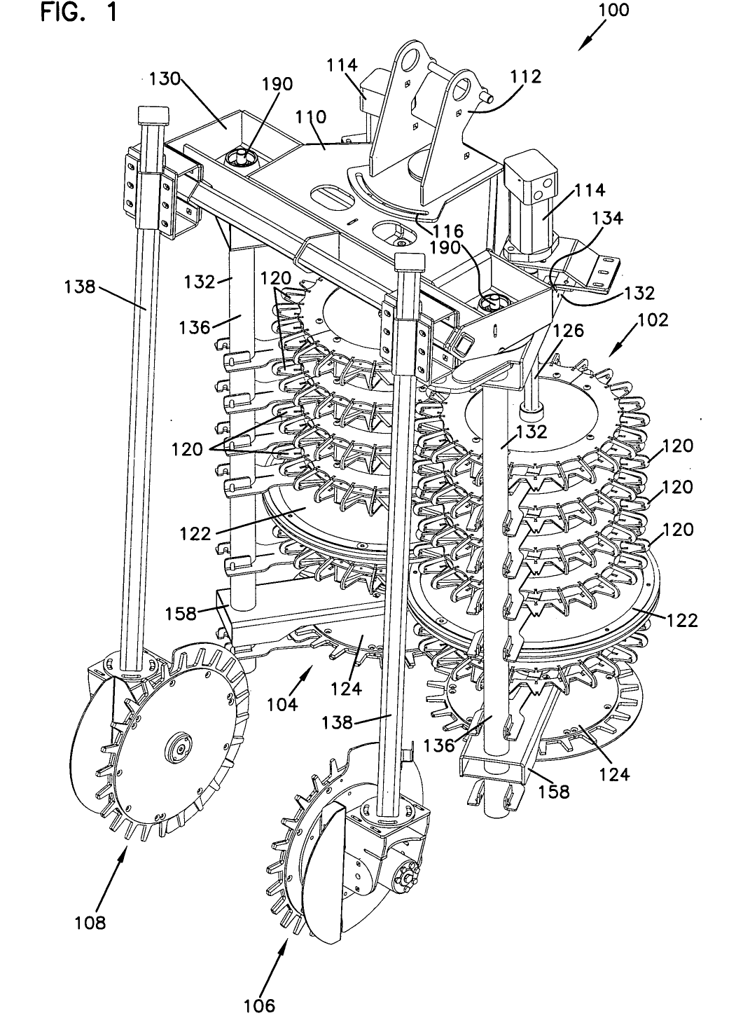

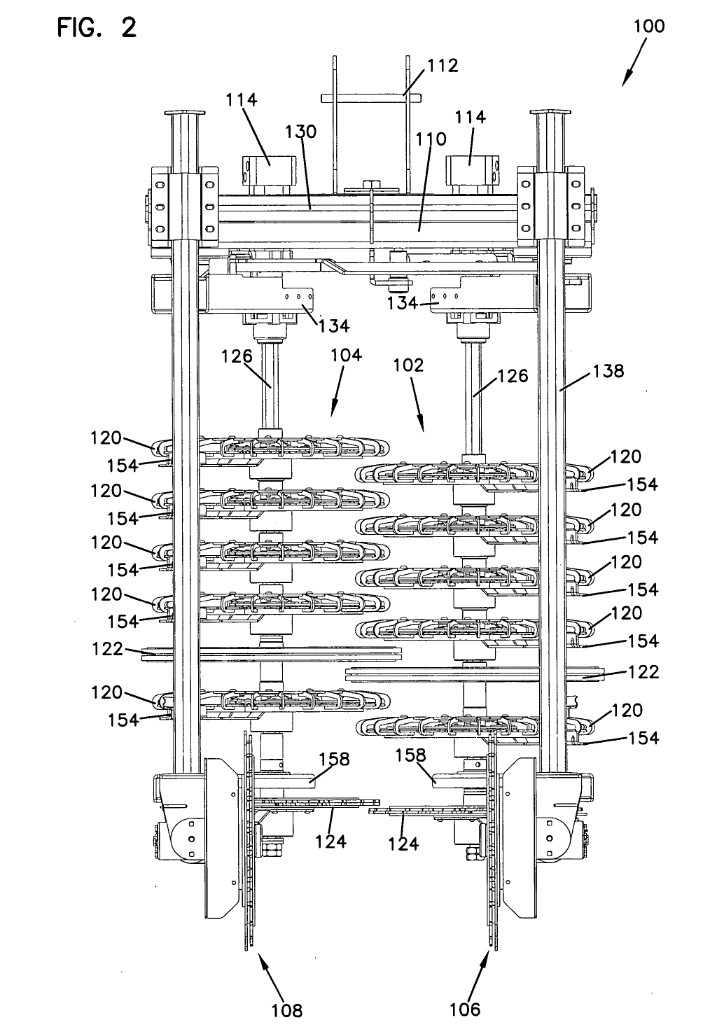

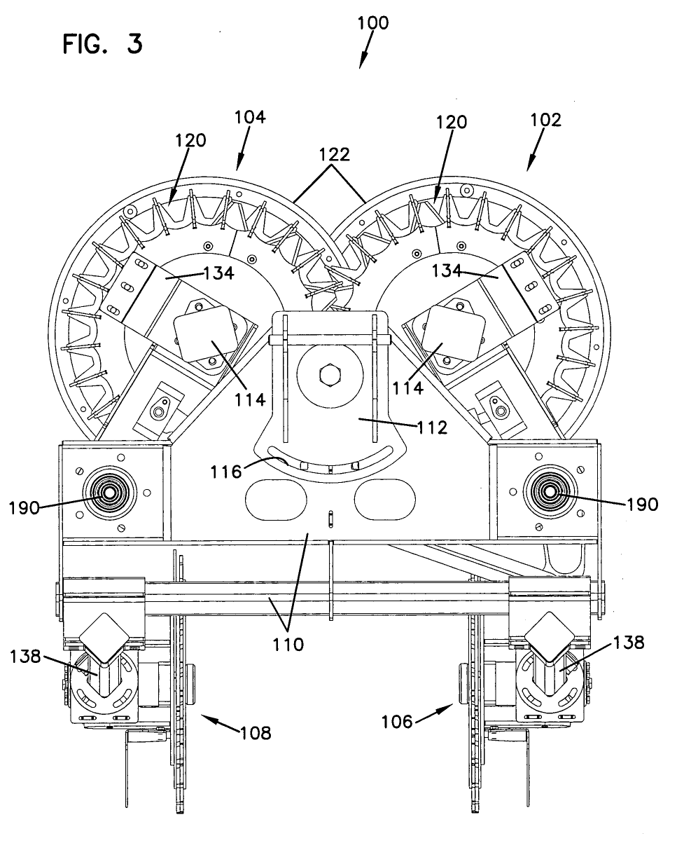

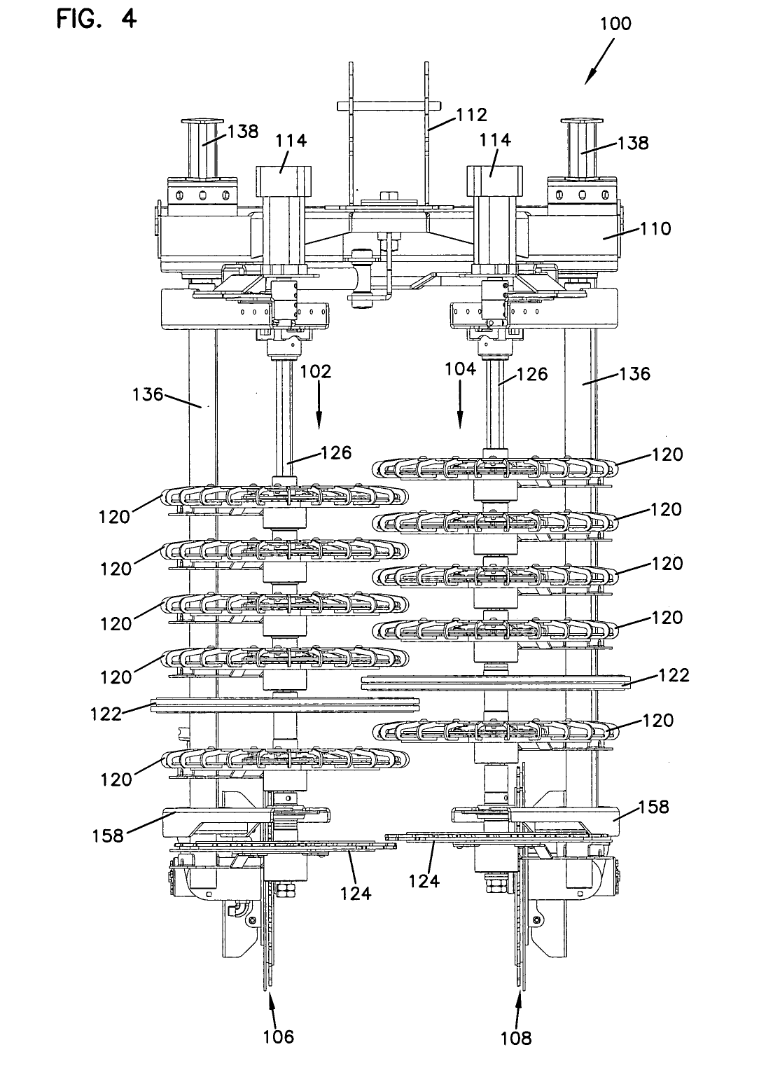

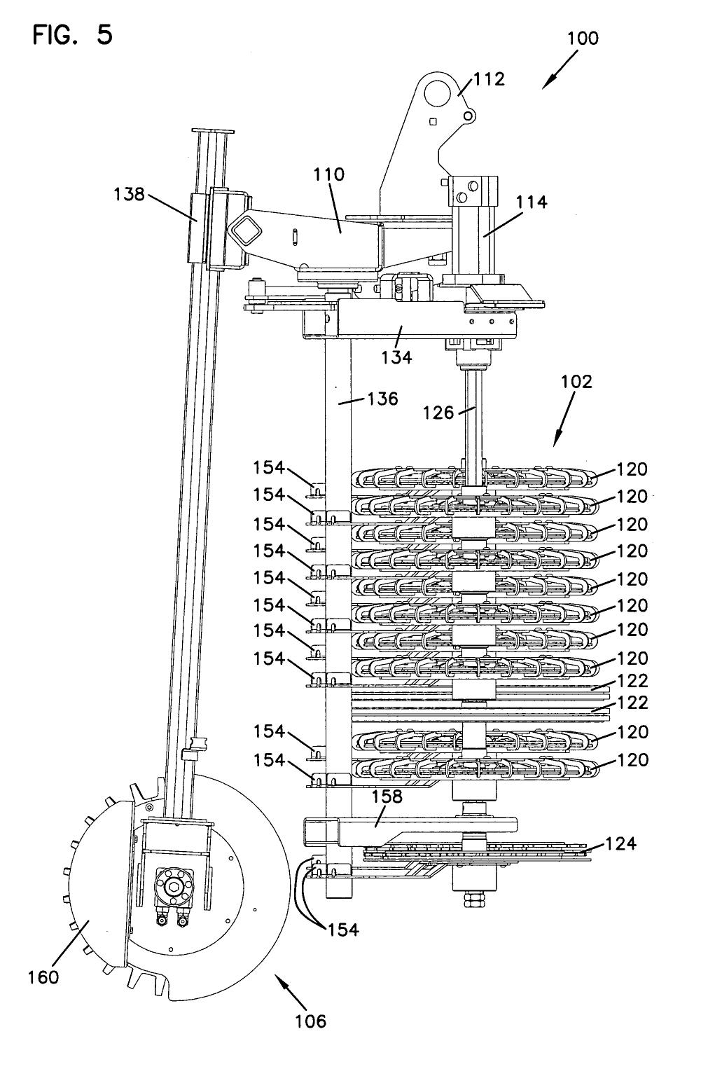

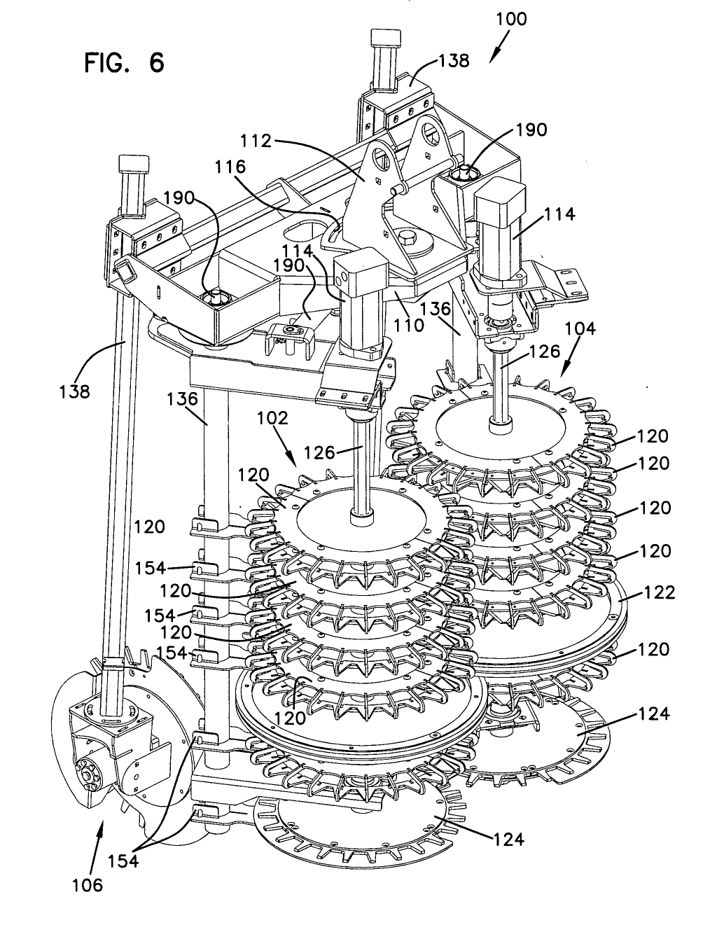

Referring now to the drawings, and in particular to FIGS. 1-7, there is shown a cutting system, generally designated 100, configured for cutting away portions of plants, such as grapes trained on trellises in vineyards. The cutting system 100 includes first cutting assemblies 102 and 104. Although one of the cutting assemblies 102 and 104 may be shown or described hereinafter, the cutting assemblies 102 and 104 are substantially the same except for being configured for cutting on the left portion or right portion of the system 100. In a first embodiment, the cutting system 100 also includes second cutting assemblies 106 and 108, which are also substantially the same as one another, but are configured for the left or right sides of the cutting system 100.

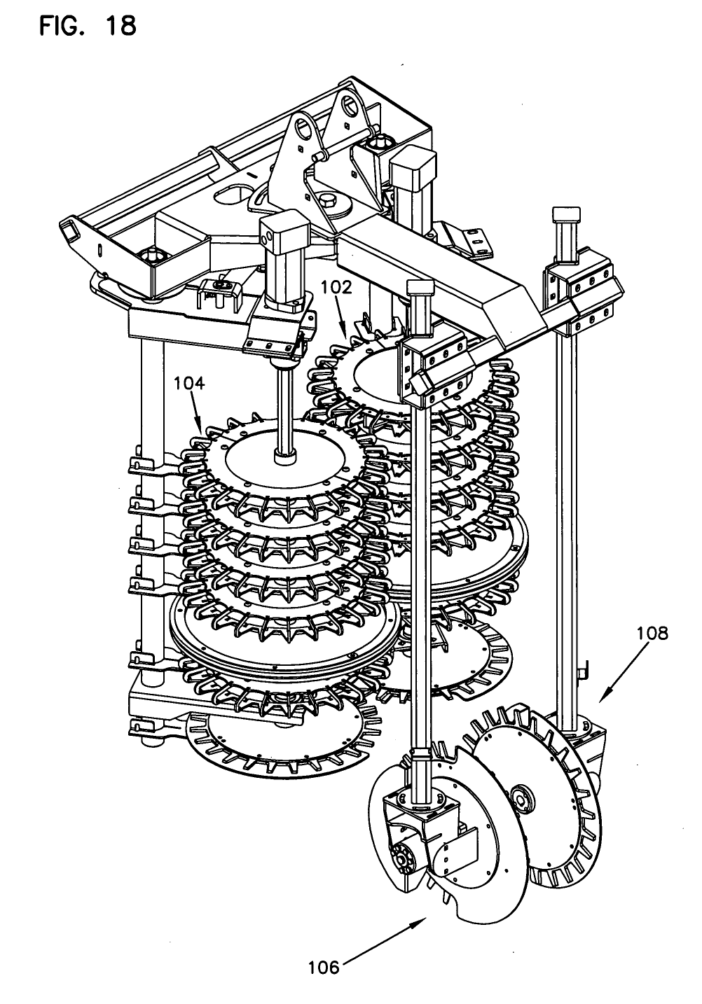

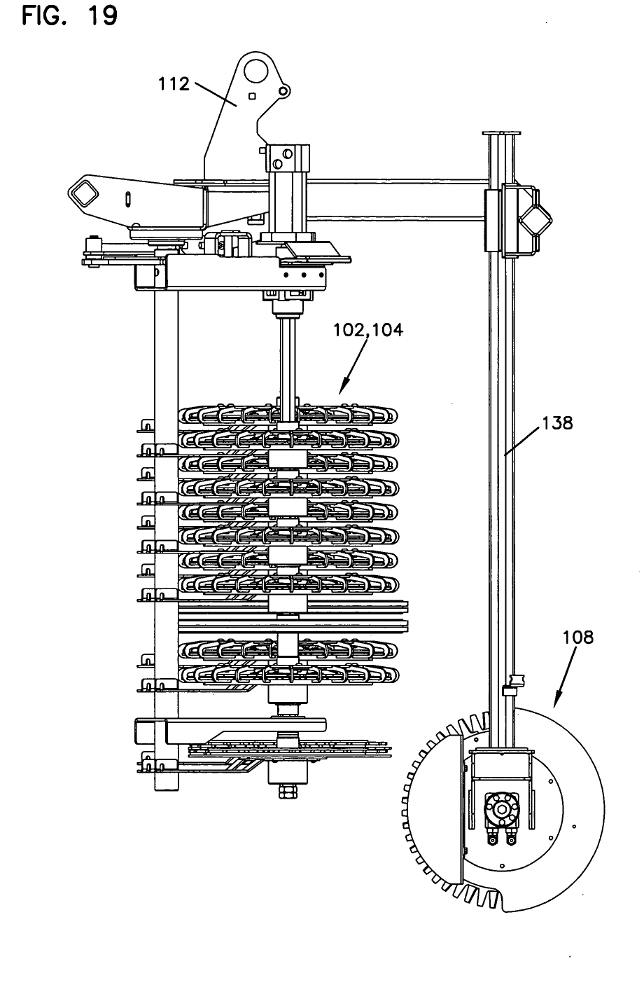

The cutting system 100 is configured for being supported on a frame 110 from above on a hanging mount 112. The hanging mount 112 includes an adjustment bracket 116 to vary the system position as needed. The mount 112 may hang on a boom mounted to a trailer or a self-propelled chassis. In the embodiment shown in FIG. 1, the system 100 is configured so that the second cutting assemblies 106 and 108 are at a forward portion of the system 100 such that the second cutting assemblies 106 and 108 first engage the plants to be pruned as the system 100 moves along the intended direction of travel. However, as shown in FIGS. 18 and 19, the system 100 may also be configured so the first cutting assemblies 102 and 104 are forward of the second cutting assemblies 106 and 108. The cutting assemblies 102, 104, 106 and 108 are configured for forming a box shaped profile for vines trained on vertical type trellises, such as VSP (vertical shoot positioned) and ballerina trellis systems, as well as other trellis systems to improve quality at a desired yield.

The first cutting assemblies 102 and 104 include several cutters 120, an opener wheel 122 and a lower cutter 124. The cutters 120 and 124 and the opener wheel 122 are mounted about a substantially vertical axle 126 in a stacked configuration. In a preferred embodiment, the axle is hex shaped to provide for easier mounting and drive. The axle 126 is driven from above by a hydraulic motor 114, which is powered, for example, by a power take off or a hydraulic pump on the chassis or tractor. The hydraulic lines are not shown for clarity. The cutters 120 and 124 are vertically aligned to combine with the cutters 106 and 108 to cut a box type profile when pruning portions of the grapevines.

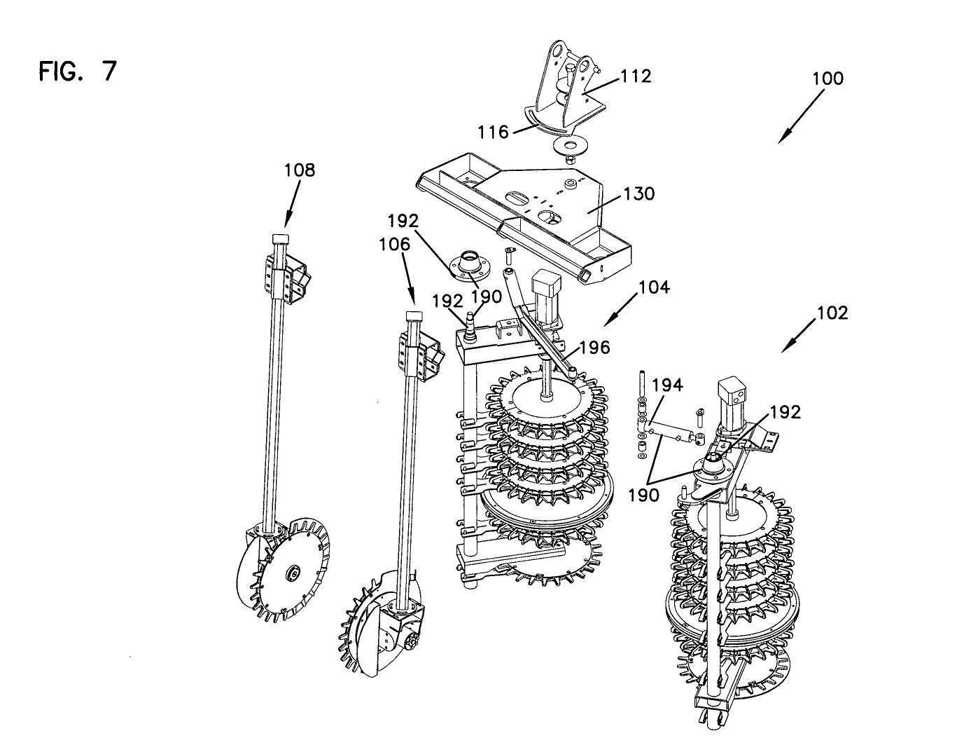

An upper frame assembly 134 and a lower frame assembly 158 support the axles 126 of the cutting assemblies 102 and 104. A bearing hub 156 provides support and facilitates easy rotation. A pivoting support member 136 receives the axle supports 134 and 158 as well as individual cutter torque arms 154. The pivot member 136 is mounted to a pivot bearing assembly 190. The pivot bearing assembly 190 allows the first cutter assemblies 102 and 104 to pivot should they strike unintended objects, such as rocks, larger plant portions, or trellis posts. As shown most clearly in FIG. 7, the pivot bearing assembly 190 forms a linkage that includes a bearing hub mounted to a spindle 192, a hydraulic cylinder 194 and a cross-parallel connecting rod 196 that allows the cutting assemblies 102 and 104 to pivot open and closed. The pivot bearing assembly 190 opens and closes as the hydraulic cylinder 194 extends and retracts.

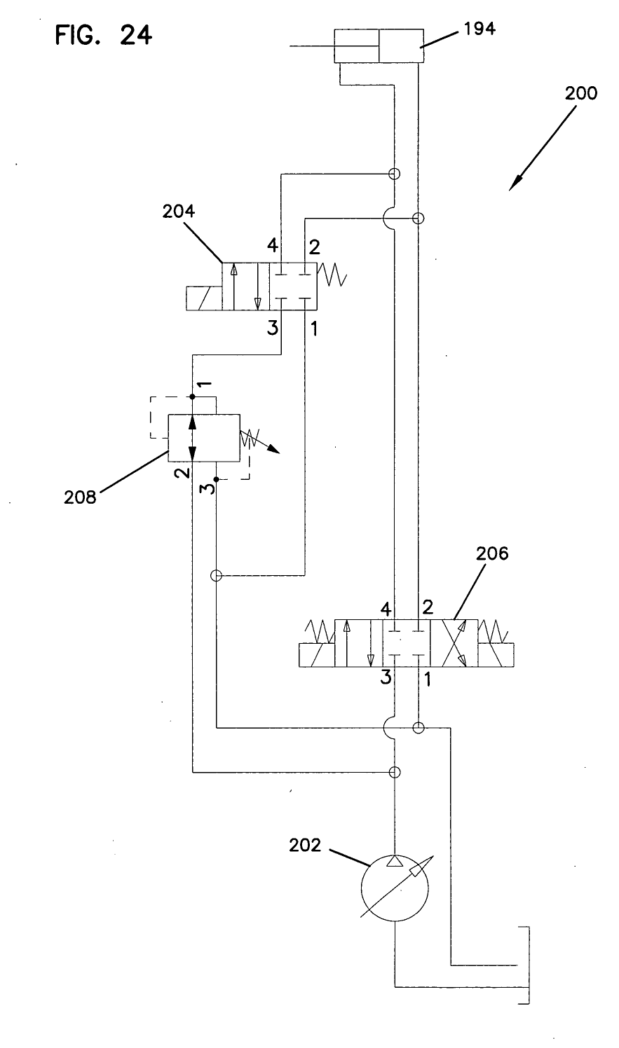

The pivot bearing assembly 190 cooperates with the hydraulic control circuit 200, shown in FIG. 24, to position the cutter assemblies 102 and 104 and to provide for pivoting the assemblies 102 and 104. The hydraulic control system 200 is a reducer/reliever, 3-position 4-way control circuit that performs two coordinated functions. The control system 200 includes a 2-way valve 202, bi-directional 3 way control valves 204 and 206 and a variable pressure valve 208. The first function of the control circuit 200 is to provide directional control to the hydraulic cylinder 194 to open and close the cutting assemblies 102 and 104. In the first position, the cutting assemblies 102 and 104 are closed for operation, and in the second position, the cutting assemblies are pivoted open for entering and exiting rows. The second function of the control system 200 is to provide a reducer/reliever function to the cylinder 194. The control system 200 performs both of these functions and integrates them to work as one cohesive system.

In the reducer/reliever mode, the 2-way valve 202 is positioned to expose the hydraulic cylinder 194 to the valve 208. At this position, the cylinder 194 has a reduced hydraulic pressure applied to it, causing a force in one direction to be applied. In the event that a greater external force in the opposite direction were applied to the cylinder 194, the cylinder would move in the opposite direction until the external force ceased to be greater. At that time, the reduced pressure would automatically re-extend the cylinder 194.

If the operator chose to manually open up the cutting assemblies 102 and 104, the reducer/reliever valve 208 is isolated from the cylinder 194 through the use of the 2-position, 2-way valve 202 and flow is directed through only the bi-directional valves 204 and 206. In this way, the 3-position, 4-way valve 208 is not interfered with in its normal operation.

Upon entering a row, the operator typically has the reducer/reliever valve 208 isolated, and the bi-directional control valve 204 is positioned with the cylinder 194 at the open position. As the cutting system 100 fully enters the trellis row and is ready to begin working, the valve 202 is changed so the reducer/reliever valve 208 is exposed to the cylinder 194, causing the cylinder 194 to close.

As a trellis post or other object approaches and comes in contact with the opener wheels, creating an external force greater than that of the reduced hydraulic pressure applied to the cylinder 194, the cylinder extends and allows the cutting assemblies 102 and 104 to open up and clear the post. The cylinder 194 then retracts and automatically closes the cutting assemblies 102 and 104 as it passes. The pressure needed to open the cutting assemblies may be varied by adjusting the valve 204.

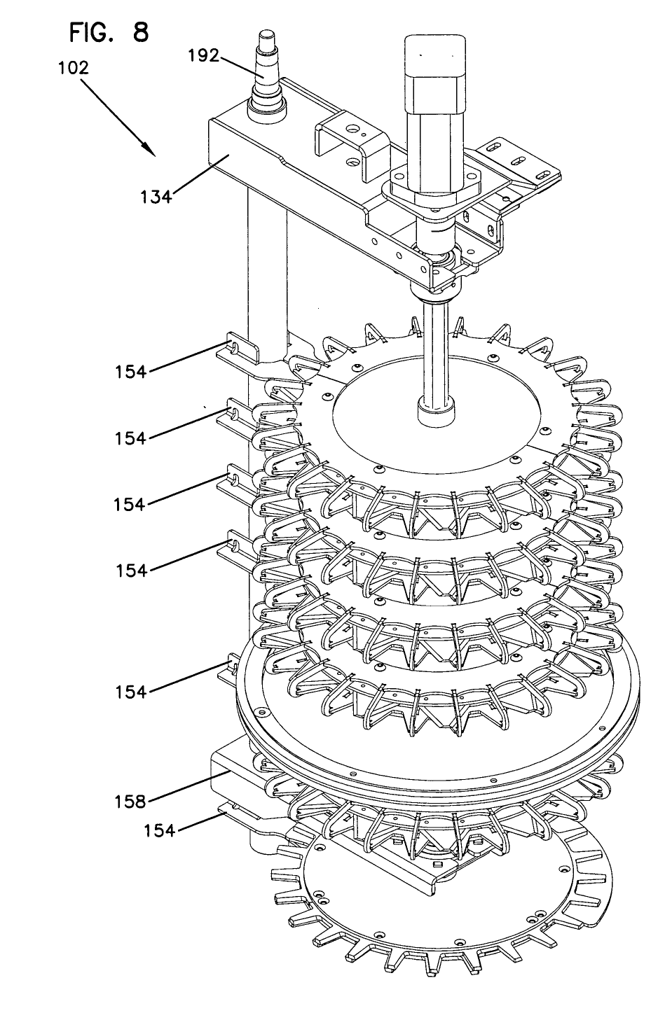

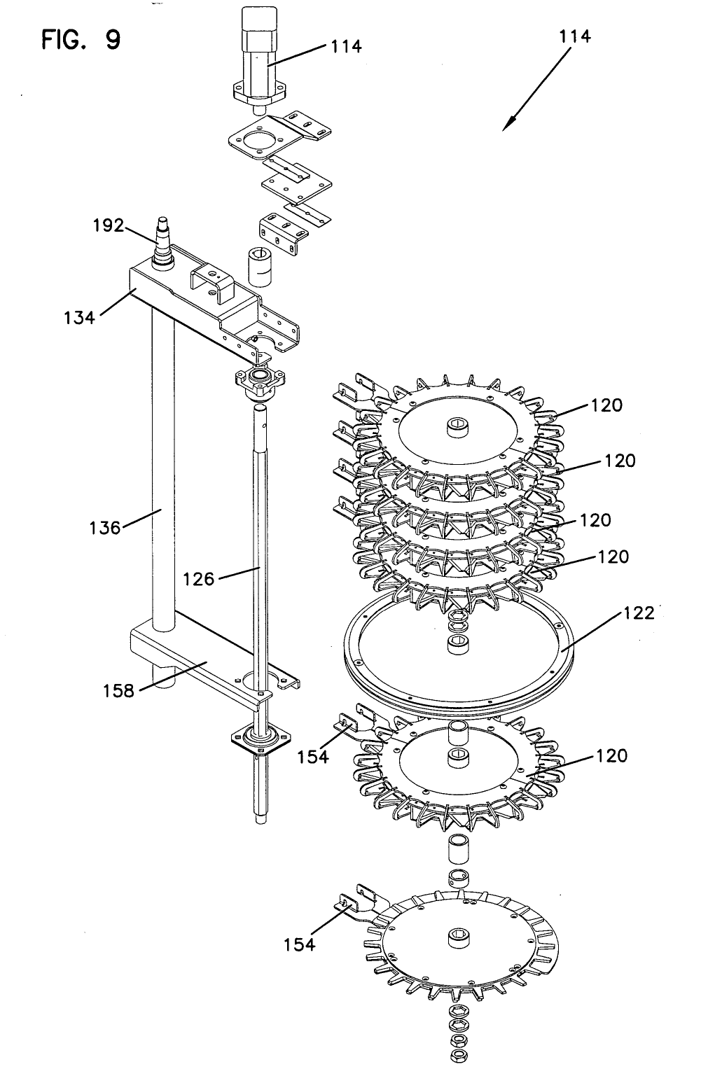

Referring now to FIGS. 8, 9, 12 and 13, the first cutting assemblies 102 and 104 include a number of vertically aligned upper cutter assemblies 120. The cutter assemblies 120 are stacked vertically on the axle shaft 126. The stack also includes an opener wheel 122. The precise arrangement and number of cutter assemblies 120 may be varied depending upon the grape variety, the trellis configuration and other growing conditions and parameters. For example, more or fewer cutter assemblies 120 may be utilized. In addition, the opener wheel 122 may be placed higher or lower on the shaft 126.

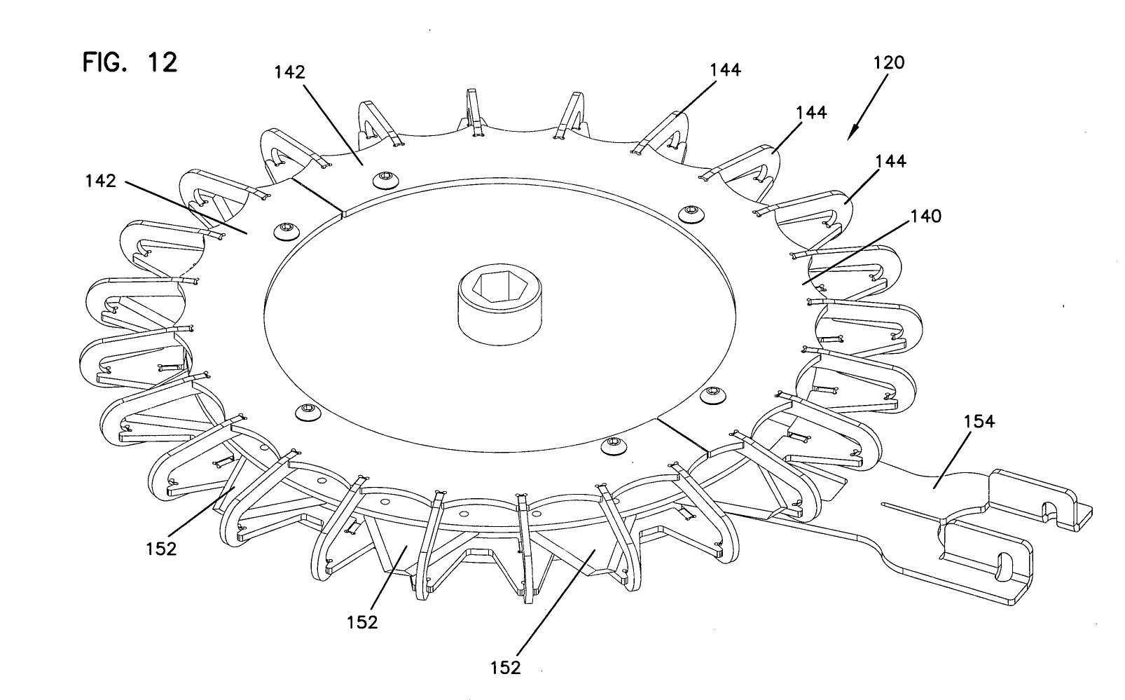

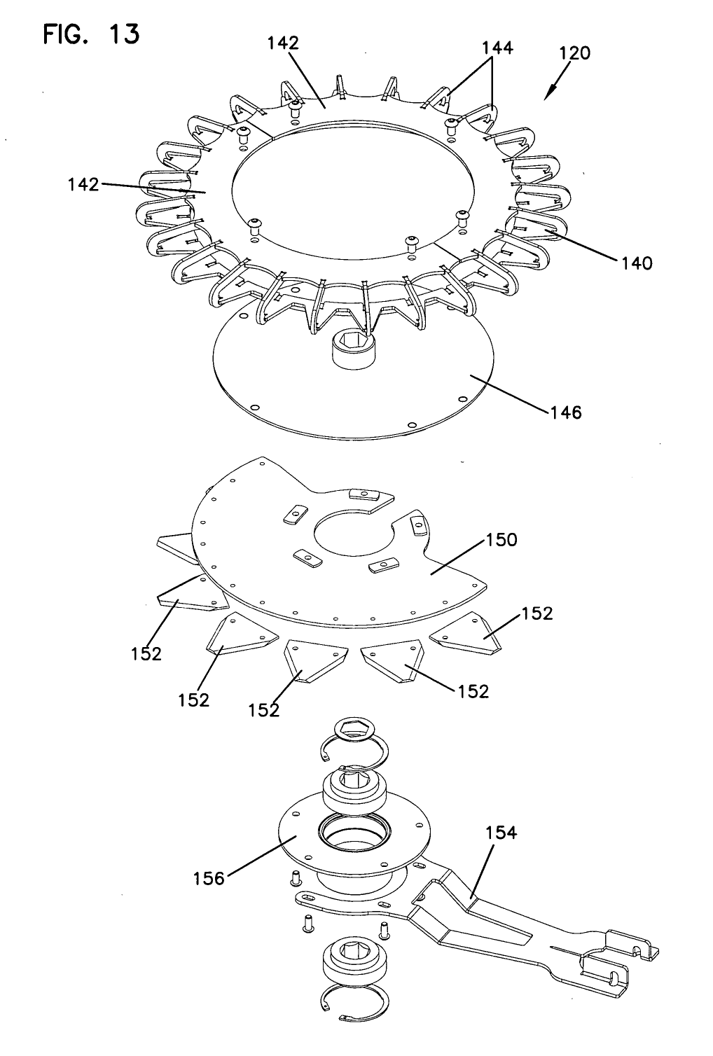

As shown most clearly in FIGS. 12 and 13, each of the cutter assemblies 120 includes cage type guard assemblies 140. The guard assemblies 140 are preferably formed of two halves 142 that allows for easy insertion and removal by sliding radially inward and outward. The guard portions 142 mount to a disc 146 configured for receiving the shaft 126. A cutter disc 150 includes cutting elements 152 around a portion of the disc 150 that engages and cuts the plants. The cutting elements 152 are stationary, but the guard assemblies 140 are driven and include outer cage portions 144 extending around, above and below the cutting elements 152. The outer portions of the guard 144 engage the plants and pull portions of the plants across the cutting elements 152 to create a scissor type action that creates shearing of the plant portions. It can be appreciated that driving the guards 140, rather than having exposed blades extending from the assemblies 102 and 104 improves safety as well as saving wear and replacement of cutting elements. The cutter assemblies 120 are held stationary by a torque arm 154 and a bearing assembly 156.

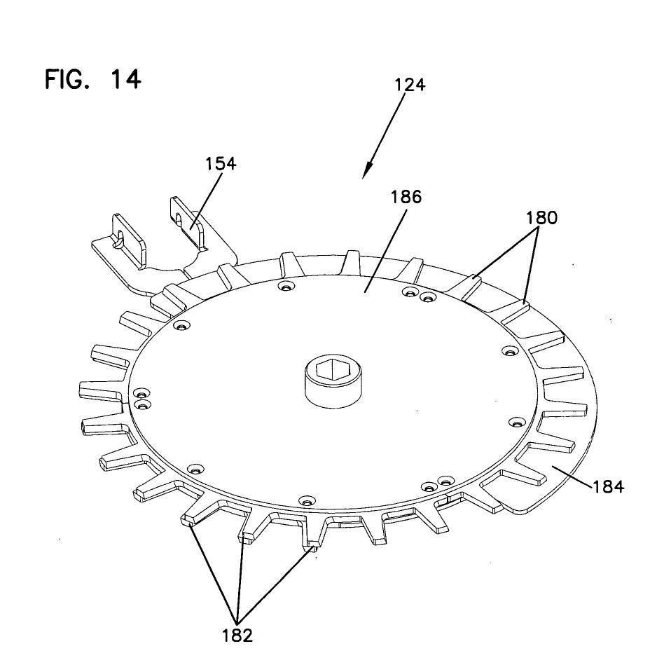

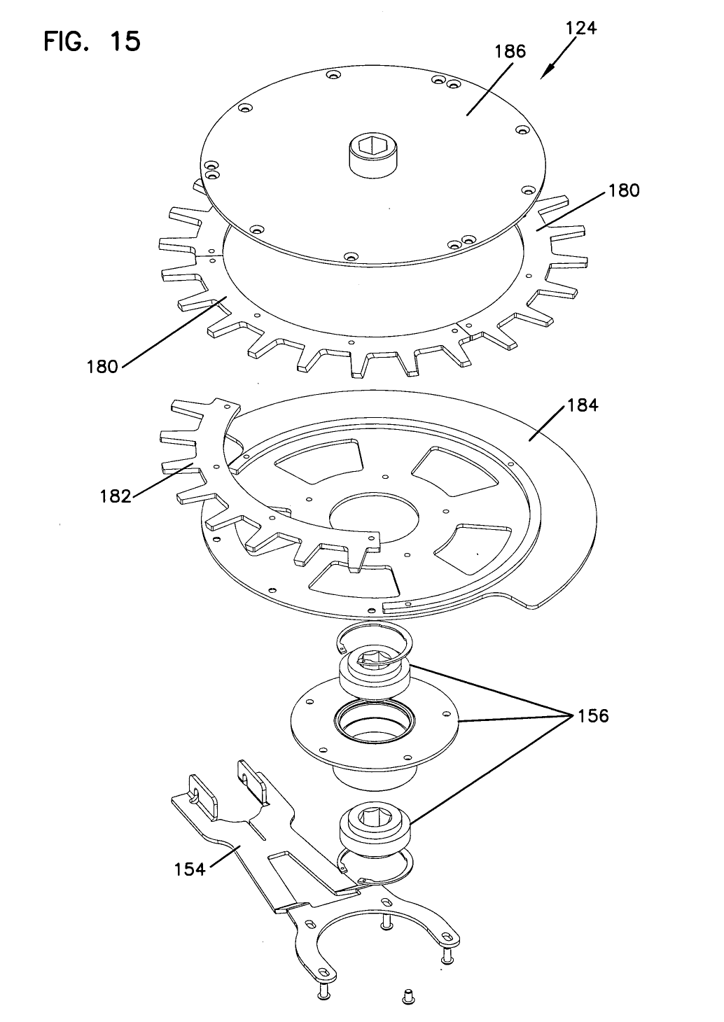

Referring now to FIGS. 14 and 15, each of the cutting assemblies 102 and 104 also includes a lower cutter assembly 124. The lower cutter assembly 124 provides a slightly different type cut that is more precise than the cut provided by the upper cutter assemblies 120. Such cutting creates more of a true box type profile being cut along the rows of grapevines. The lower cutting assembly 124 has a slightly smaller diameter than the upper cutter assemblies 120 to decrease the likelihood of engaging objects at a lower level. The lower cutter assemblies 124 include rotating cutter members 180. As with the guards of the upper cutters, the cutter members 180 are preferably configured in a semi circular configuration so that the sections form a complete circular cutter. However, it can be appreciated that other configurations that provide for radial removal and insertions are also contemplated by the present invention. The semi-circular configuration allows for easy radial insertion and removal. The cutters mount to a disc 186 that engages the hex shaft 126 of the cutting assemblies 102 and 104. A stationary cutter 182 includes cutting elements that cooperate with the rotary cutter 180 to provide a precise shearing action. A guard 184 receives the stationary cutter 182 and mounts to the support bracket 154. The bearing assembly 156 provides support for rotation.

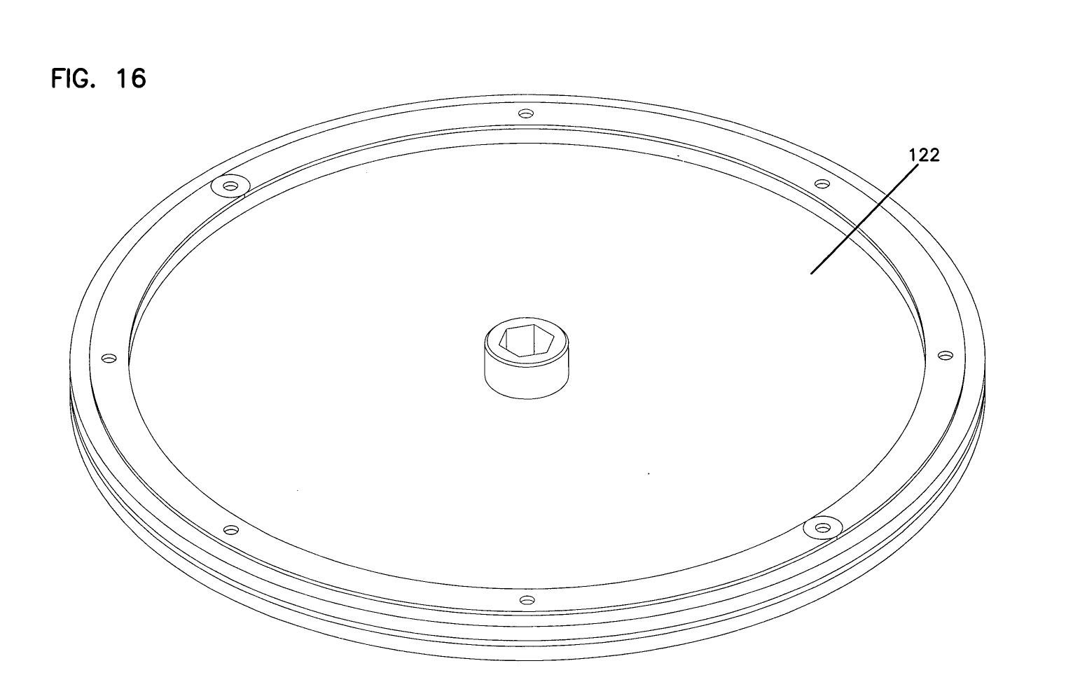

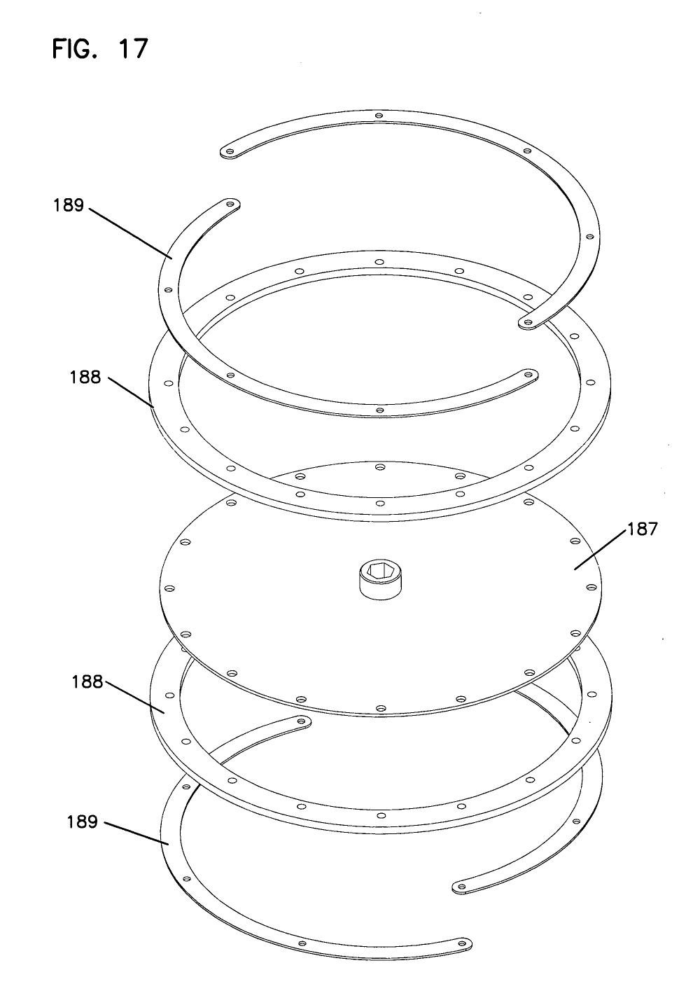

Referring now to FIGS. 16 and 17, the opener wheel 122 of each of the cutting assemblies 102 and 104 is configured to have a diameter slightly larger than the cutter assemblies 120 and 124. With such a configuration, the opener wheels 122 engage posts and other stationary objects, so that the cutters 120 and 124 are maintained spaced apart from objects and do not strike the posts. The opener wheels 122 include a mounting disc 187 with rings 188 having a diameter slightly larger than the disk 187 and are held by retainer members 189. The control system 200 along with the pivot bearing assembly 190 and the opener wheels 122 cooperate to allow the first cutting assemblies 102 and 104 to maintain a position that removes a desired amount of plant portions and also prevents damage from trellis posts and other objects. It can be appreciated that each of the cutting assemblies 102 and 104 drives all elements by a single motor 144, as all driven elements are mounted on a single shaft 126.

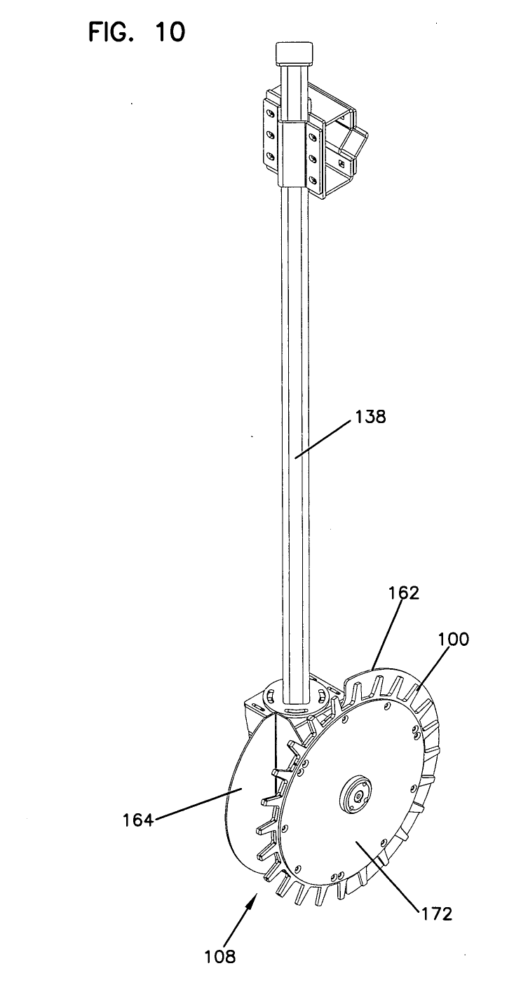

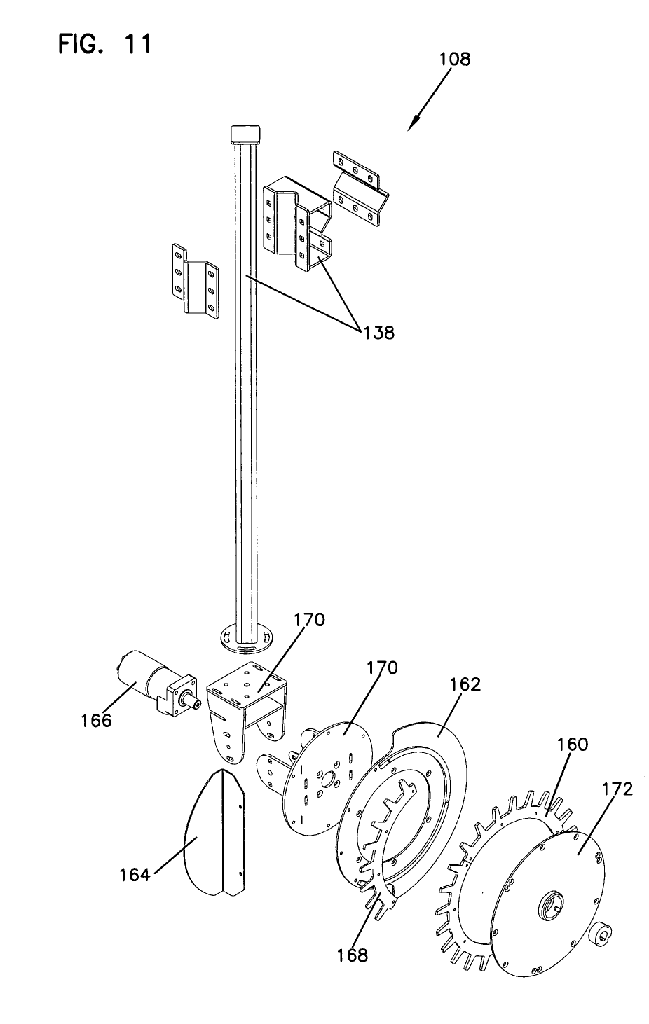

Referring now to FIGS. 10 and 11, there is shown a first embodiment of a right hand second cutting assembly 108. Although a right hand assembly is shown, it can be appreciated that the right hand assembly is substantially the same as a left hand assembly and the following description applies to both assemblies 106 and 108. The second cutting assembly 108 includes a support 138 including a mounting bracket and a substantially vertical mounting post. The second cutter assemblies 106 and 108 use a cutting configuration similar to the lower cutting assemblies 124. The cutting assembly includes a circular rotating cutter 160 and a stationary cutter 168. The stationary cutter 168 extends only a portion along the front of the cutting assembly at the area engaging and cutting the plants. The cutters 160 and 168 cooperate to provide a shearing, scissor type action and a precise cut. As the cutting assemblies 106 and 108 have cutting elements oriented about a substantially horizontal axis, the cutting elements 160 and 168 provide a precise side cut and help to clear an opening to leave a box shaped profile. The rotating cutter 160 mounts to a disk 172 that is driven by a motor 166. A mounting assembly 170 supports a guard 162 receiving the stationary cutter member 168. A side guard 164 extends along the stationary cutter member 168. The motors 166 may be any well known hydraulically motor driven from a power take off or hydraulic pump from the chassis or tractor supporting the cutting system 100. The mounting assembly 170 provides for vertical, horizontal and angular adjustment of the cutting portions of the assembly 106 and 108.

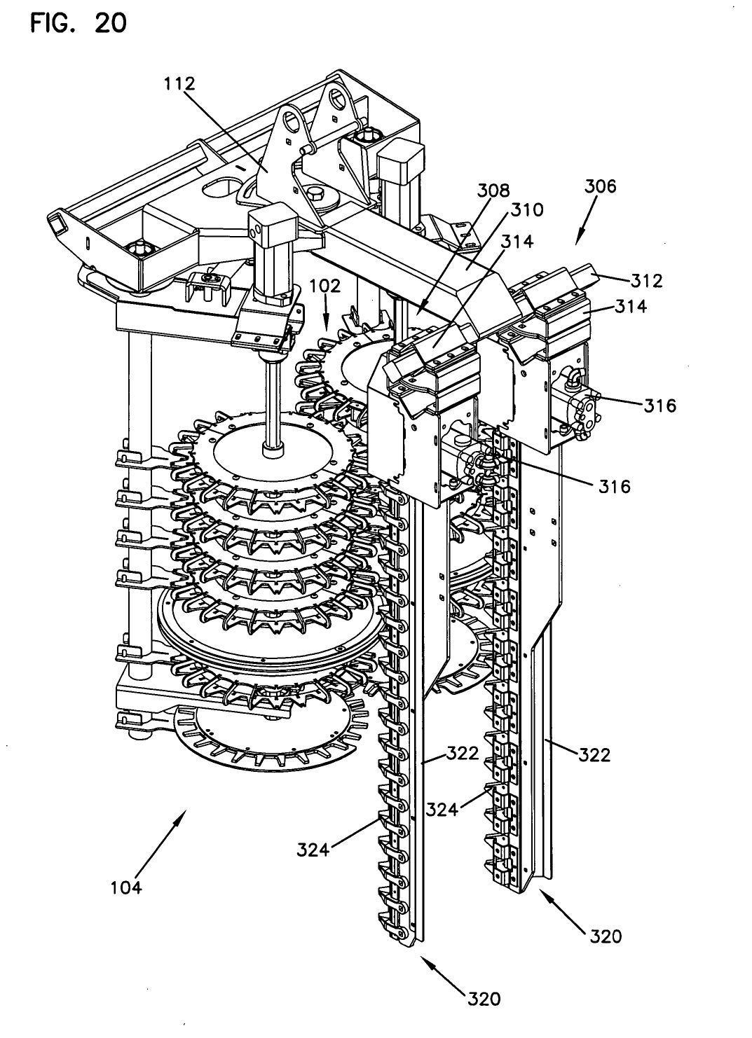

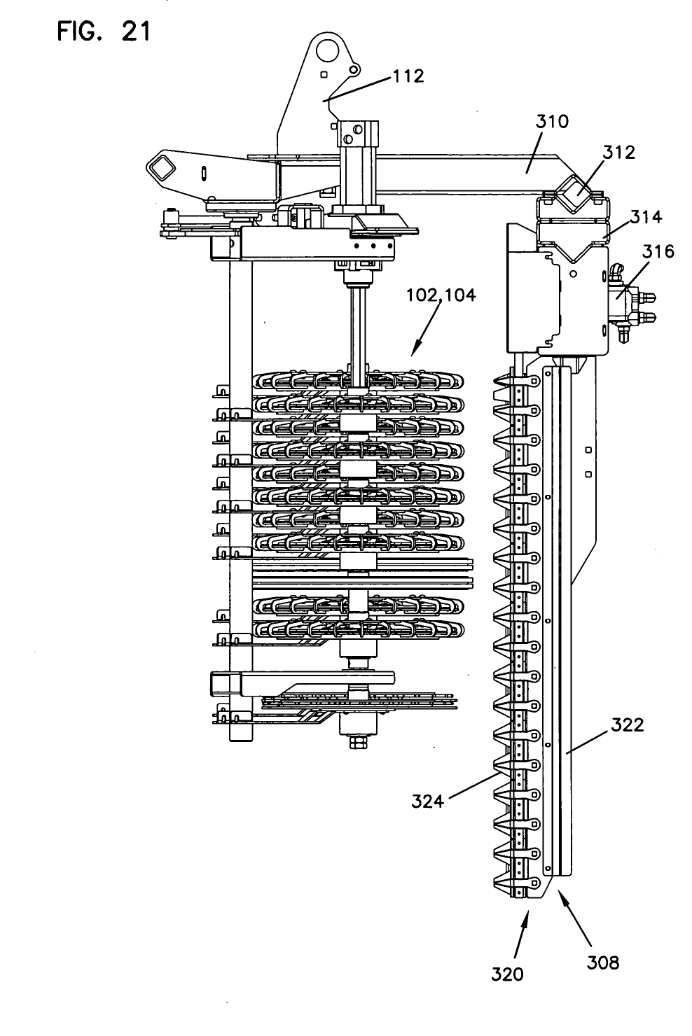

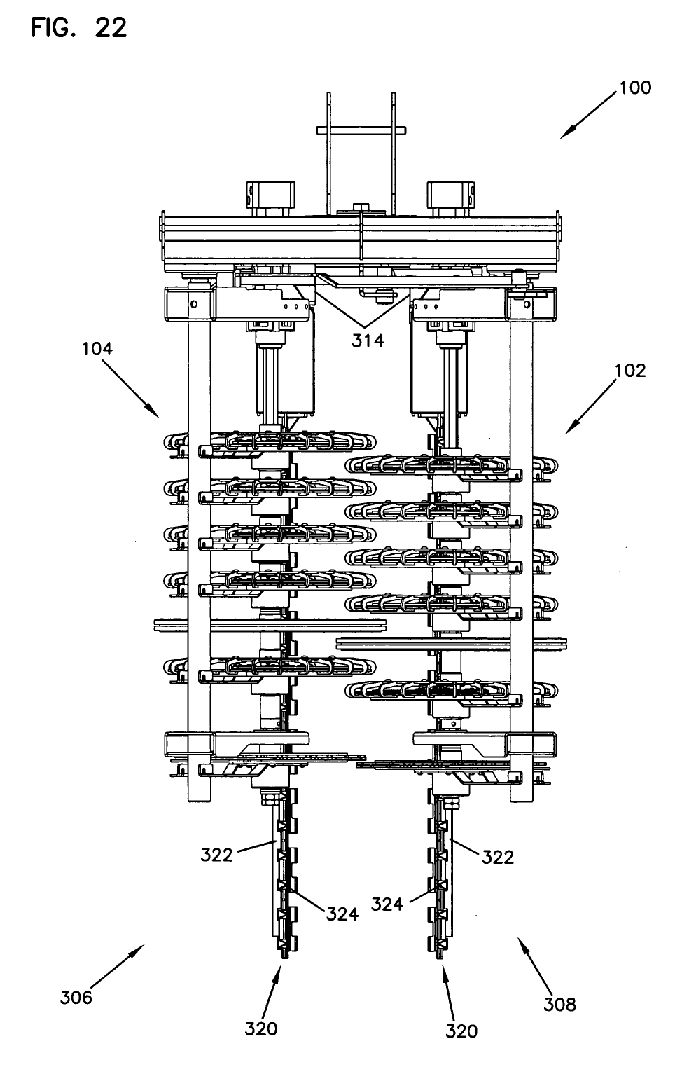

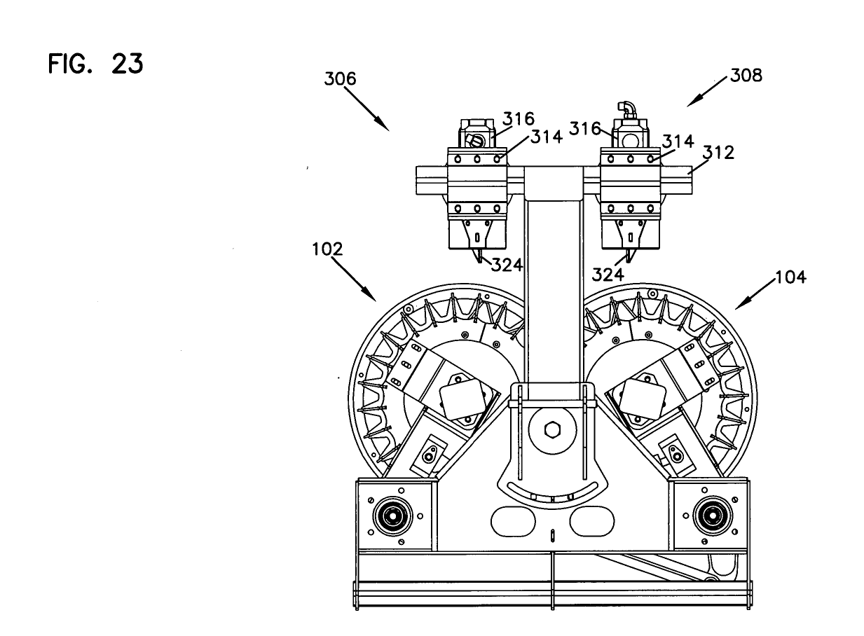

Referring now to FIGS. 20-23, there is shown a second embodiment of second cutter assemblies, generally designated 306 and 308. Each of the second cutting assemblies 306 and 308 is mounted on an upper frame 310 including a mounting bar 312. Each of the cutting assemblies includes a mounting bracket 314 that clamps to the mounting bar 312. The lateral position of each of the cutting assemblies 306 and 308 may be varied by changing the mounting location on the bar 312. A hydraulic motor 316 powers each of the cutting assemblies 306 and 308. A sickle bar 320 includes a vertical support 322 and a reciprocating sickle blade 324. The sickle bar assembly 320 reciprocates in a back and forth, up and down motion to provide a precise side cut and cooperates with the first cutting assemblies 102 and 104 to form a box shaped profile. It can be appreciated that the sickle bar assemblies 306 and 308 provide for variable spacing as the sickle bar assemblies 306 and 308 are moved on the mounting bar 312. Moreover, the speed may be varied through the control system 800 by changing the speed of the motor 316. It can further be appreciated that as with the second cutting assemblies 106 and 108, the sickle bar assemblies 306 and 308 may be mounted either in front of or behind the first cutting assemblies 102 and 104.

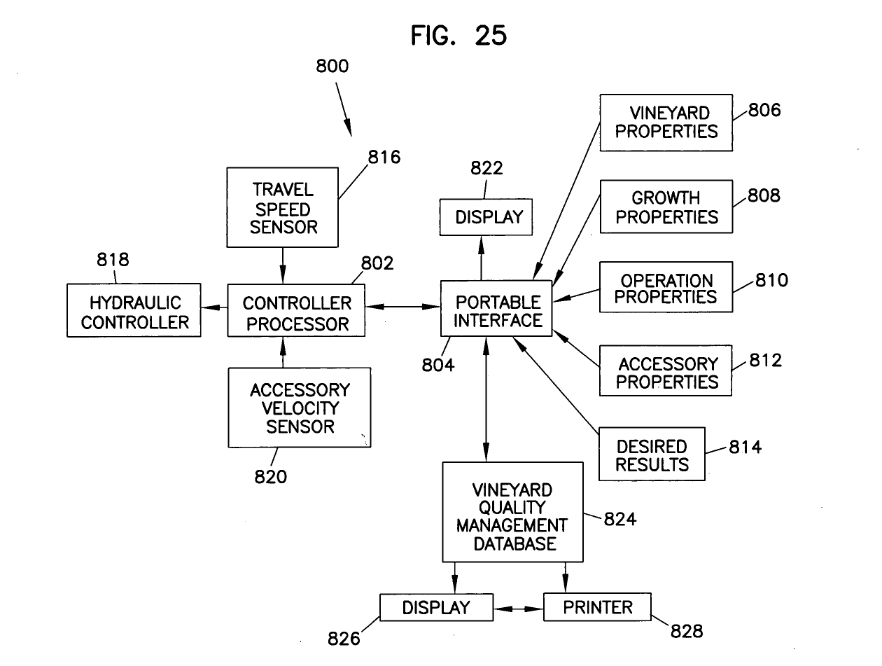

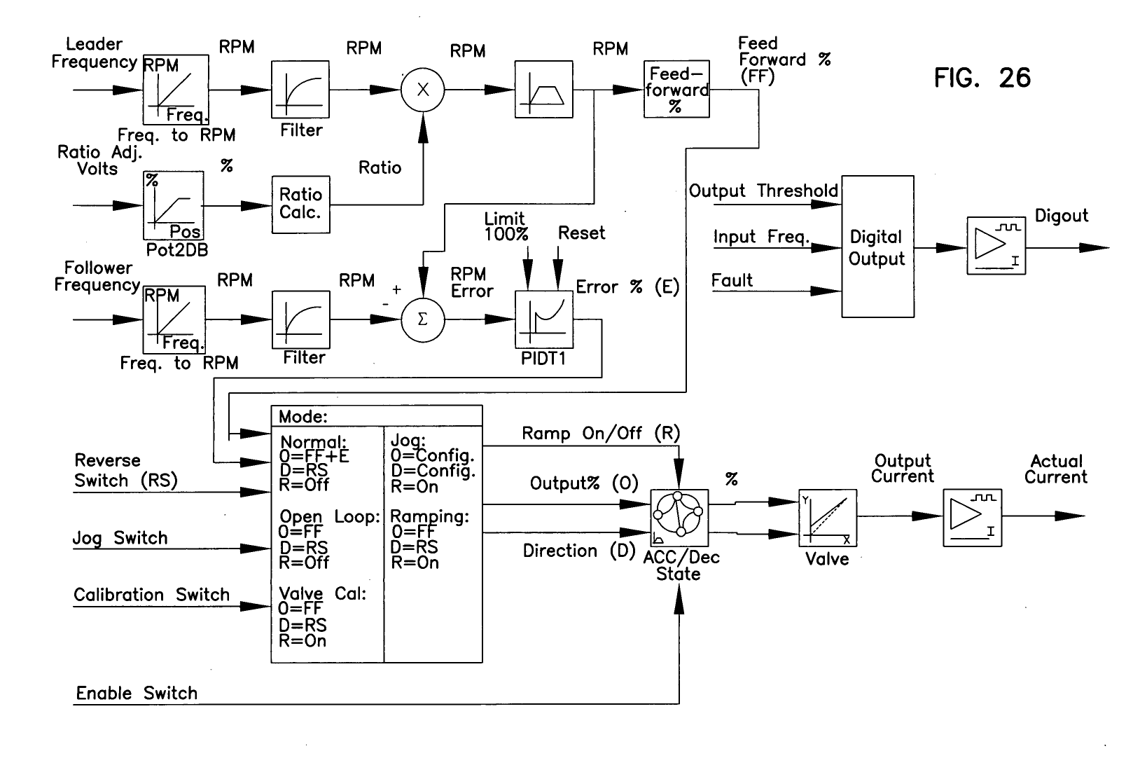

Referring now to FIG. 25, there is shown a control system for the mechanized system 100. The controller 800 includes a central processor 802, such as SX controllers available from Sauer-Danfoss Company. FIG. 26 shows a typical block diagram for the control system 802. Referring again to FIG. 25, the processor 802 is accessed through an interface unit, such as a hand held portable interface 804, which may include screens with prompts to ask for various inputs to control the various operations of the cutting system 100. The portable interface may be a Palm Pilot brand or similar device that includes a memory, display, inputs and download capabilities. The portable interface unit 804 may utilize various factors that are entered. Various vineyard properties 806 may be input and stored, such as the grape variety, type of trellis, the density of the plants, the age of the plants, and other properties of the various vineyards. It is foreseen that measurements may be taken before and after each operation such as weights, shoot counts, berry counts, cluster counts, leaf area and other characteristics. Although the characteristics may be input for each vineyard, it can be appreciated that the properties may also be applied to various lots or tracts that are further subdivisions of a particular vineyard. Moreover, visual sampling or sampling taken by hand or from automatic devices, such as a weighing device, may also be utilized and input and rates adjusted in response to the sampling results. Cluster count, weight, yield and other data may be measured and recorded for current season and future use.

The control system 800 provides for maintaining the cutting assemblies at a constant proportional speed relative to ground speed. For example, the typical ground travel speed might be 1.5 miles per hour. The periphery of the cutting assemblies 102 and 104 may be driven at a typical speed of approximately 4 miles per hour with rotary speed indicated to an operator on a tachometer or other similar device. It has been found through testing that superior results are achieved when the relative speed of the cutting assemblies at periphery is approximately 2-3 times the ground speed. The control system also provides for varying the relative speed as conditions vary based on terrain, grape varietal, growing conditions, trellis and other parameters. Moreover, as the number and configuration of the various cutting assemblies are varied, the rotational speed might also be varied to achieve preferred results. The controller also preferably provides for maintaining the cutter assemblies at a rotational speed between rows at a minimum rotational speed, so the system 100 does not need to ramp up to cutting speed from a standstill. Once a row has been entered, the controller again maintains the proportional rotational speed.

In operation, the cutting system 100 is maintained so that the cutters are at a minimum rotational speed before entering a row. Once the row has been entered, the second cutting assemblies 106 and 108 or 306 and 308 first engage the canopy on either side of the trellis and provide precision side cuts to remove a portion below the canopy. As the first cutting assemblies 106 and 108 enter the row, the opener wheels 122 engage posts to maintain the cutting assemblies 102 and 104 at a position that prevents the cutters 120 and 124 from striking posts and causing damage. The pivot bearing assembly 190 and the hydraulic control system 200 provides tension. The present invention provides for easily modifying the configuration and number of cutting assemblies as well as the relative rotational speed of the assemblies through the control system 100 to maintain a precise high quality cut from the plants. The present invention provides for a safe, reliable cutting system 100 that achieves precise and controlled removal that is not possible with the prior art.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A cutting apparatus for removing portions of plants, comprising:
a plurality of first cutting assemblies mounted about a substantially vertical axis, wherein each of the first cutting assemblies includes a stationary cutting disc;
a plurality of guards, wherein each of the guards is associated with one of the first cutting assemblies, wherein each of the guards comprises a cage substantially surrounding the associated cutting disc;
a motor coupled to and driving the guards.

2. A plant cutting apparatus according to claim 1, further comprising a second cutting assembly mounted about a substantially horizontal axis.

3. A plant cutting apparatus according to claim 2, wherein the second cutting assembly is spaced apart from the first cutting assemblies along a direction of travel.

4. A plant cutting apparatus according to claim 1, further comprising a second cutting assembly including a substantially vertically extending sickle bar.

5. A plant cutting apparatus according to claim 4, wherein the second cutting assembly is spaced apart from the first cutting assemblies along a direction of travel.

6. A plant cutting apparatus according to claim 1, further comprising a lower cutting assembly having a stationary cutting disc and a rotating cutting disc.

7. A plant cutting apparatus according to claim 6, wherein the rotating cutting disc is coupled to and driven by the motor.

8. A plant cutting apparatus according to claim 6, wherein the stationary cutting disc and the rotating cutting disc each comprises a plurality of cutting portions spaced about a periphery of the disc.

9. A plant cutting apparatus according to claim 6, wherein the lower cutting assembly has a smaller diameter than the first cutting assemblies.

10. A plant cutting apparatus according to claim 1, wherein the first cutting assembly is pivotally mounted to pivot between an operating position and a transport position.

11. A plant cutting apparatus according to claim 10, further comprising a position control system for controlling the position of the first cutting assemblies.

12. A plant cutting apparatus according to claim 11, wherein the position control system comprises a hydraulic cylinder mounted to the first cutting assembly and a hydraulic control circuit in fluid communication with the cylinder.

13. A plant cutting apparatus according to claim 1, further comprising a speed controller for controlling the operating speed of the first and second cutting assemblies.

14. A plant cutting apparatus according to claim 13, wherein the speed controller maintains a constant proportional operating speed that is substantially constant relative to a travel speed of the cutting apparatus.

15. A cutting system for plants, comprising:
a first cutting arrangement comprising:
a plurality of guards;
a motor driving the plurality of guards;
a first cutting assembly associated with each guard in a generally vertical configuration, wherein the first cutting assembly comprises a stationary cutter;
a second cutting arrangement comprising:
a second cutting assembly comprising a cutter mounted about a generally horizontal axis and spaced apart from the first cutting assembly.

16. A cutting system according to claim 15, wherein system comprises at least two first cutting arrangements and at least two second cutting arrangements.

17. A cutting system according to claim 16, wherein the first cutting arrangements are configured to define a passage for receiving a portion of a plant there between and wherein the second cutting arrangements are configured to define a passage for receiving a portion of a plant there between.

18. A cutting system according to claim 17, wherein the system is configured for moving along a direction of travel and wherein the second cutting arrangements precede the first cutting arrangements.

19. A cutting system according to claim 15, wherein the first cutting arrangement further comprises a third cutting assembly including a stationary cutter and a rotating cutter.

20. A plant cutting apparatus, comprising:
a plurality of first cutting assemblies mounted about a substantially vertical axis, wherein each of the first cutting assemblies includes a stationary cutter and an associated guard, wherein each of the guards comprises a cage substantially surrounding the associated cutter;
a lower cutting assembly having a stationary cutter and a rotating cutter; and
a motor coupled to and driving the guards and the rotating cutter.

21. A plant cutting apparatus according to claim 20, further comprising a second cutting assembly mounted about a substantially horizontal axis.

22. A plant cutting apparatus according to claim 21, wherein the second cutting assembly is spaced forwardly from the first cutting assemblies along a direction of travel.

23. A plant cutting apparatus according to claim 21, wherein the second cutting assembly is spaced rearwardly from the first cutting assemblies along a direction of travel.

24. A plant cutting apparatus according to claim 20, wherein each of the stationary cutters and the rotating cutter comprises a disc having a plurality of cutting portions spaced about a periphery of the disc.

25. A plant cutting apparatus, comprising:
a plurality of spaced apart first cutting assemblies mounted about a substantially vertical first axis, wherein each of the first cutting assemblies includes a stationary cutting disc;
a plurality of spaced apart second cutting assemblies mounted about a substantially vertical second axis, wherein each of the second cutting assemblies includes a stationary cutting disc;
wherein the first and second cutting assemblies are offset vertically, and wherein the first axis and the second axis are space apart;
a plurality of guards, wherein each of the guards is associated with one of the first and second cutting assemblies, wherein each of the guards comprises a cage substantially surrounding the associated cutting disc;
a first lower cutting assembly mounted along the first axis having a stationary cutter and a rotating cutter and a second lower cutting assembly mounted along the second axis having a stationary cutter and a rotating cutter;
a first motor coupled to and driving the guards of the first cutting assemblies and the rotating cutter of the first lower cutting assembly; and a second motor coupled to and driving the guards of the second cutting assemblies and the rotating cutter of the second lower cutting assembly.

26. A plant cutting apparatus according to claim 25, wherein the first cutting assemblies at least partially extend into the second cutting assemblies.

27. A hydraulic position control system, comprising:
a hydraulic cylinder having a first end and a second end, wherein the cylinder is movable between a first extended position and a second retracted position;
a pressurized hydraulic fluid source;
a hydraulic control circuit in fluid communication with the cylinder and the hydraulic fluid source, the circuit comprising:
a first valve comprising a two position two way valve in fluid communication with the pressurized fluid source;
a second valve comprising a reducer/reliever valve in fluid communication with the pressurized fluid source and the hydraulic cylinder through the first valve;
a third valve comprising a three position two way valve in fluid communication with the first end of the cylinder, the second end of the cylinder, the first valve, the second valve, and the pressurized fluid source; and
a fourth valve comprising a three position two way valve in fluid communication with the first end of the cylinder, the second end of the cylinder, the pressurized fluid source, the first valve, the second valve, the third valve.
